(19) United States
(12) Patent Application Publication
(10) Pub. No.: US 2004/0117788 A1
(43) Pub. Date: Jun. 17, 2004

(54) Method and system for TV interface for coordinating media exchange with a media peripheral

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,076

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/444,108, filed on Jan. 30, 2003.

(51) Int. Cl. G06F 9/44

(52) U.S. Cl. 717/177; 717/172; 717/103

(57) ABSTRACT

Aspects of the invention may be found in a method and system for communicating media and may comprise controlling communication of media from a television without consuming the media by the television. Under control of the television, the media may be transferred from a first location to at least one media peripheral located at a second location. A command initiated from or through the television may also cause media to be transfer from the first location to the second location. At least one command may be received that may effectuate the transfer of media from the first location to the second location. Accordingly, at least one request may be received by the television and utilized to facilitate or control transfer of the media. The television may redirect media from a first location to a second location with the media being received and/or consumed by the television.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001P-BP-2800) filed Dec. 11, 2002;

U.S. Provisional Application Serial No. 60/443,894 (Attorney Docket No. 14274US0101002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/444,108 (Attorney Docket No. 14275US01 010003P-BP-2802) filed Jan. 30, 2003.

This application also makes reference to:

U.S. application Ser. No. ______ (Attorney Docket No. 14185US02 01001P-BP-2800) filed Sep. 8, 2003; and

U.S. application Ser. No. ______ (Attorney Docket No. 14274US02 01002P-BP-2801) filed Sep. 11, 2003.

All of the above stated applications are incorporated herein by reference in their entirety.

### FIELD OF THE INVENTION

Certain embodiments of the invention relate to control of information transfer in a media exchange network. More specifically, certain embodiments of the invention relate to a method and system for a TV interface for coordinating media exchange with a media peripheral.

### BACKGROUND OF THE INVENTION

Currently, televisions are utilized simply to consume media such as audio and video. Devices such as VCR's and DVD players feed an audio and/or a video signal to a television, and the television is utilized to consume the media encoded within the signal. In this regard, the media is utilized by the television itself. Control of the DVD player and VCR are accomplished via the television and various control commands are driven like a channel broadcast to the television. The television therefore treats the control commands like any other channel broadcast and displays the commands. Even if the incoming signal to the television is an auxiliary input or a raw video input, the television merely displays the media carried by the signal. Accordingly, the television simply performs standard television broadcast channel processing and displays the media. Any media manipulation has already been accomplished in the media player or the device that generates the signal for the television before the signal gets to the television.

Audio selection and a television guide look-and-feel are currently provided by a set-top-box and are also delivered to a television as a broadcast channel. Again, in this case, the television merely performs standard television broadcast channel processing and displays the delivered media. Although a user may make selections using, for example, the television guide look-and-feel displayed on the television screen, these user selections are actually made on the set-top-box. Therefore, the set-top-box controls what is delivered to the television.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the invention may be found in a method for supporting communication of media. The method may include controlling communication of the media from a television without consuming the media by the television and transferring the media from a first location to at least a second location as controlled by the television. The first and the second locations may be co-located or remotely located. Notwithstanding, at least one command may be generated from the television that causes transfer of the media. In this regard, one or more commands may also result in transfer of the media from the first location to the second location and at least one request received by the television may be utilized to control communication of the media. Responses to some of the requests may also result in transfer of the media. The first location and the second location may correspond to a location of a media peripheral, a media processing system, a media storage system, a personal computer and/or and a media provider.

Another aspect of the invention may include displaying a user interface on a display of the television that may facilitate or control transfer of the media. Transfer of the media from the first location to one or more other locations may also be scheduled so that the media may move from the first location to the other locations without being consumed, received and/or stored by the television. In another aspect of the invention, transferred media may be stored in the first location and/or the second location.

Another embodiment of the invention may provide a machine-readable storage, having stored thereon, a computer program having at least one code section for supporting communication of media. The at least one code section may be executable by a machine, thereby causing the machine to perform the steps as described above in the method for supporting communication of media.

The invention may also provide a system for supporting communication of media within a home. Aspects of the system may comprise a media peripheral, a television and a communication pathway that operates independent of the television through which the media is delivered. The television may be utilized to arrange media delivery to the media peripheral for playback on the media peripheral. The television may be adapted to and/or utilized to generate at least one command that causes delivery of the media. The television may also respond to one or more commands and the response may result in delivery of the media. The television may also display a user interface that may be utilized to control delivery of the media. The user interface may provide an indication or representation of the media peripheral such as an icon, which upon selection, may initiate delivery of the media.

Another aspect of the invention may also include a media peripheral located at a first home and a television located at a second home. The television may be adapted to and/or utilized to arrange delivery of media to the media peripheral. The television may retrieve stored media and transfer the stored media to at least one of a media peripheral located at a first home and a media peripheral remotely located with respect to a first home. The television may also be adapted to schedule the delivery of media to the media peripheral. Delivery of media may be redirected by the television to a media peripheral without the television receiving and/or consuming the media.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a schematic block diagram illustrating an exemplary TV-based exchange processing functionality over an exemplary media exchange network in accordance with an embodiment of the present invention.

FIG. 2 is a schematic block diagram illustrating communication flow using the TV-based exchange processing of FIG. 1 in accordance with an embodiment of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention may be found in a method and system for supporting communication of media. Aspects of the method for supporting communication of media may comprise controlling communication of the media from a television without consuming the media by the television. The media may also be transferred from a first location to one or more locations including a second location without being consumed by the television. The first and the second locations may be co-located or they may be remotely located. In either case, at least one command may be generated from the television that causes transfer or delivery of the media. Accordingly, one or more commands may also result in the media being transferred from the first location to the second location. At least one request received by the television may be utilized to control transfer or delivery of the media. Responses to some of the requests received by the television may also result in the media being transferred or delivered from the first location to one or more other locations. The first location and the second location may correspond to a location of a media peripheral, a media processing system, a media storage system, a personal computer and/or and a media provider.

Another aspect of the invention may also include displaying a user interface may facilitate or control transfer of the media on a display of the television. Transfer of the media from the first location to one or more other locations may also be scheduled so that the media may move from the first location to the other locations without being consumed, received and/or stored by the television. In another aspect of the invention, transferred media may be stored in the first location and/or the second location.

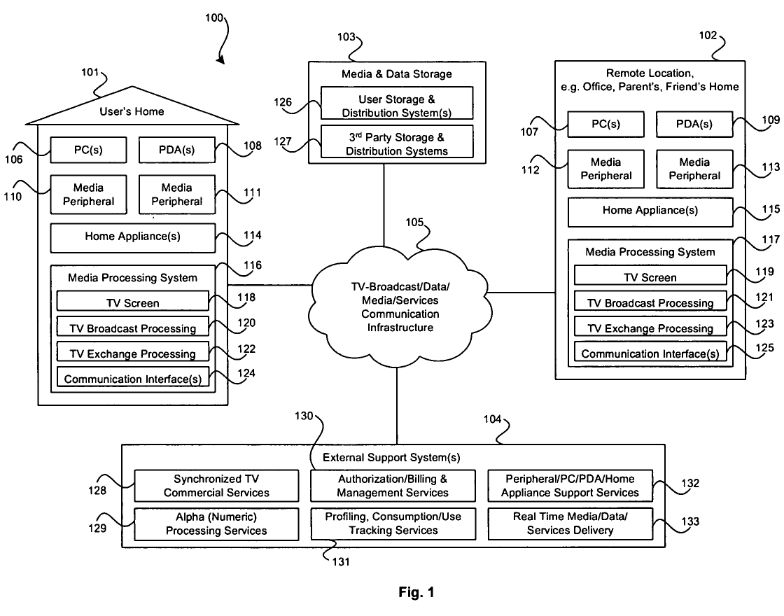

FIG. 1 is a schematic block diagram illustrating an exemplary television-based exchange processing functionality over an exemplary media exchange network 100 in accordance with an embodiment of the present invention. Referring to FIG. 1, the media exchange network 100 may include a first location such as a user's home 101, a remote location 102, media and data storage 103, external support systems 104, and a communication infrastructure 105. The communication infrastructure 105 may provide a common communication transport that may link the user's home 101, the remote location 102, the media and data storage 103 and the external support systems 104. The remote location 102 may include, for example, an office, a parent's home, and/or a friend's home.

The first location or user's home 101 may include PC 106, PDA 108, media peripherals 110, 111, home appliance 114, and a media processing system (MPS) 116. The remote location 102 may include PC 107, PDA 109, media peripherals 112, 113, home appliance 115 and a media processing system (MPS) 116 and 117 respectively. Media peripherals, as used herein, may include media capture devices, media player devices and any combination thereof. The media capture devices may include, for example, digital cameras and digital camcorders. The media player devices may include, for example, WMA and MP30 players. Although the media peripherals may be integrated with a personal computer, the invention is not limited in this regard. Accordingly, media peripherals may be external to the personal computer and may be standalone or portable devices. A personal computer (PC) comprising media exchange software (MES) running on or being executed by the personal computer, may also be referred to as a media processing system.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

A fully integrated media processing system having a television screen may be designed from the ground up having full media processing capability. The media processing systems 116, 117 may be fully integrated media processing systems. Media processing system 116 may include a television screen 118, a television broadcast processing platform 120, a television exchange processing platform 122 and communication interfaces 124. Media processing system 117 may include a television screen 119, a television broadcast processing platform 121, a television exchange processing platform 122 and communication interfaces 124, 125. Alternatively, a set-top-box may be software enhanced and interfaced with television to form a media processing system.

The communication infrastructure 105 may include cable infrastructure, xDSL infrastructure, Internet infrastructure, intranet infrastructure or other similar access and/or transport infrastructure that may facilitate the exchange of media and/or data between, for example, the user's home 101 and the remote location 102 and/or the media and data storage 103. The media and data storage 103 may include user storage and distribution systems 126 and also third party storage and distribution systems 127.

The external support systems 104 may include synchronized TV commercial services 128; alpha/numeric processing services 129; authorization/billing and management services 130; profiling, consumption/use tracking services 131; peripheral/PC/PDA/home appliance support services 132; and real time media/data/services delivery 133.

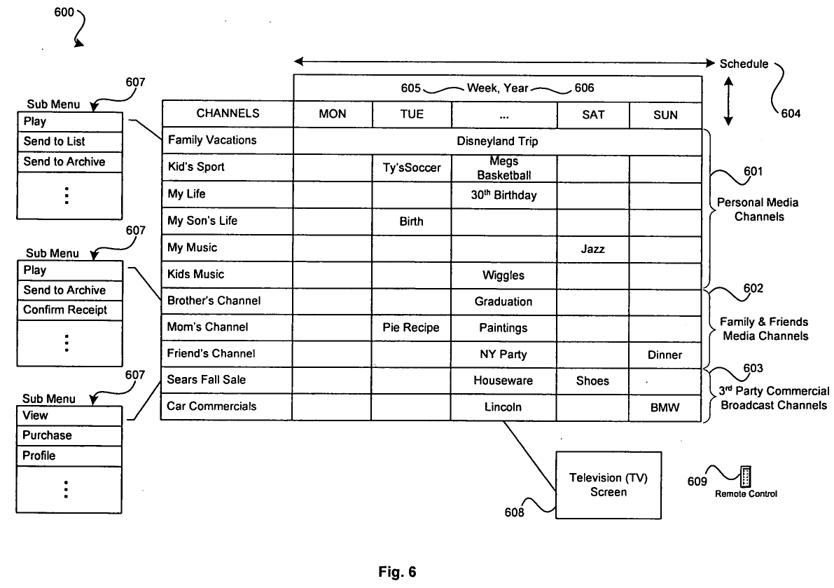

In general, a television screen may be utilized to coordinate the exchange of media, data, and/or services between devices that are part of a media exchange network. For example, television screen 118 may be utilized to coordinate the exchange of media, data, and/or services between devices that are part of the media exchange network 100. The television screen may be utilized to execute setup, initiate and control functions for the exchange of media in conjunction with a media processing system such as MPS 116. The television exchange processing platform 122 may provide a television guide look-and-feel to a user. In accordance with an aspect of the invention, the television guide look-and-feel may be displayed to the user as a television channel guide user interface. FIG. 6 illustrates an exemplary channel user guide interface 600 having a television guide look-and feel.

The television (TV) broadcast processing platform 120, may include suitable circuitry that is utilized for broadcast channel tuning, amplification and/or decoding of media for consumption. However, the circuitry utilized for broadcast channel tuning, amplification and/or decoding is not utilized for the functions of television exchange processing, except that image generation circuitry may be utilized to drive the television screen for a television channel guide user interface.

In an illustrative media exchange embodiment of the invention, a user at the first location or the user's home 101 may have a desire to transfer pictures from media peripheral 110 to PDA 108 using the television screen 118 and a remote control to command the exchange. The media peripheral 110 may be a digital camera and the 108 television screen 118 may have a television guide look-and-feel. During the media exchange process, the pictures are not actually being consumed or viewed by the user on the television screen. Accordingly, the core or heart of the television broadcast processing platform 120, which includes channel tuning, amplification and/or decoding, is not being utilized. The television exchange processing platform 122 in the media processing system 116, however, is being utilized to coordinate, command, and accomplish the exchange. The communication interfaces 124 provide the interface between the television screen 118 and the television exchange processing platform 122 in the media processing system 116.

In another illustrative embodiment, a user at the first location or user's home 101 may have a desire to transfer digital pictures from their digital camera 110 to the remote media processing system (MPS) 117 situated at the remote location 102. In this regard, the user may issue a command that may cause the pictures to be transferred from the digital camera 110 to the remote media processing system 117 via the communication infrastructure 105. In this case, the media exchange may also be coordinated by the television exchange processing platform 122 in the media processing system 116. In general, the media exchange network 100 may permit or facilitate the exchange of media from a first memory or storage location to a second memory or storage location within the network 100, using a television channel guide user interface. The television channel guide user interface may be displayed on a television screen 118.

The exchange of media may take place between various system components or entities. For example, the exchange of media may take place between two or more media peripherals 110, 111, 112, 113 such as digital cameras and PDAs, cell phones and digital cameras. The various media peripherals may be locally or remotely situated with respect to a user and/or with respect with each other. Exchange of media may take place between one or more media peripherals 110, 111, 112, 113 and one or more media storage devices 103, 106, 107. For example, data may be transferred from a digital camera to a PC using a television channel guide user interface on the TV screen 118. In another example, data may be moved from a personal computer to a hard drive of a personal video recorder (PVR) situated in the user storage and distribution system 125 or to a storage portion of the media peripheral system 116. Again, the media peripherals and/or media storage devices may be locally or remotely located with respect to a user and/or with respect with each other.

The exchange of media may also take place between a television and one or more media peripherals 110, 111, 112, 113 or media storage devices 103, 106, 107. The television, media peripherals, and/or media storage devices may be situated locally and/or remotely with respect to a user and/or with each other. In accordance with an aspect of the invention, the exchange of media may be accomplished through the use of various media peripheral control features and commands. For example, a user may utilize various specified commands to program, exchange and/or deliver audio, video, and/or image media channels. Even though the delivery may occur in real time, the invention is not so limited. Accordingly, various media peripheral control features and commands may be utilized to schedule the transfer or exchange of media.

Control of the media exchange may be scheduled, arranged or organized by a user via the television screen 118 using television exchange processing platform 122. In this regard, the television exchange processing platform 122 may control the exchange of media between two or more media peripherals. Notwithstanding, the television exchange processing platform 122 may also control the exchange of media within a single media peripheral. For example, media may be transferred from a first location such as a short term memory within a media peripheral to a second location such as an archive within the media peripheral.

Control commands for setup and delivery may be managed or handled by the television exchange processing platform 122. Alternatively, control of media exchange may be arranged by a user via a television screen 119 using a television exchange processing platform 123. The television exchange processing platform 123 may be utilized to exchange media between two or more media peripherals. However, the control commands that may actually be utilized to accomplish the exchange may be performed directly between the two media peripherals through a peer-to-peer interface, for example.

The management of memory, such as evaluating how much memory storage space is currently available or will be available in a media peripheral may be controlled using certain media peripheral commands in accordance with various embodiments of the present invention. Similarly, the moving and migrating of media files in an automatic manner may also be controlled by certain media peripheral commands. For example, a user at the first location or user's home 101 may issue a command that would result in or cause digital pictures or copies of digital pictures situated in their digital camera 110 to be stored within a memory of the local media processing system 116. In another example, the user at the first location may also issue a command the may cause or result in the pictures or copies of the pictures situated in their digital camera 110 to be archived in the user storage and distribution system 126.

A user may also initiate certain media peripheral commands that may automatically cause media to be routed to other users as soon as the digital media is created. In this regard, a user may setup or initialize a media peripheral with a level of authorization that may cause media to be automatically routed or migrated. For example, as soon as a user takes a picture with a digital camera 110 at the first location or user's home 101, the digital picture file that is generated may be automatically routed or forwarded to certain friends and family members at, for example, the second or remote location 102 via the communication infrastructure 105. The exchange may be automatically carried out by television exchange processing platform 122 in media processing system 116 without any user intervention or interaction, except for the taking of the picture.

Various third (3^{rd}) party services may also be provided by the media exchange network 100. For example, synchronized television commercial services 128 may also be provided. Television channel requests may be synchronized to commercials provided by a third (3^{rd}) party such as the external support system 104. In this regard, a particular television commercial, for example, may have an associated code that a user at the first location or user's home 101 may enter using their remote control and television channel guide user interface. The associated television commercial code may be displayed along with the television commercial on the television screen 118. The user may respond to the television commercial by entering the code within the television guide user interface displayed on the television screen 118. The code may be processed by the television exchange processing platform 122 in the media processing system 116 and transmitted via the communication infrastructure 105 to the external support system 104. Accordingly, the third (3^{rd}) party may subsequently transfer or push detailed advertisement media, for example, to the media processing system 116 at the first location or user's home 101 via the communication infrastructure 105.

Similarly, alpha-numeric processing services 129 may be provided. For example, third (3^{rd}) party providers may advertise alpha-numeric sequences over the radio or in magazines. A user having knowledge of the alpha-numeric sequences may enter the sequences using a remote control and television channel guide user interface, in order to request that the advertised media be pushed to the user via the media exchange network 100. The request may be communicated, for example, from media processing system 117 at the second or remote location 102 to the communication infrastructure 105, and then to external support system 104.

In another aspect of the invention, certain media peripheral commands may be initiated by a user for testing a media peripheral. In this regard, a user may initiate a test of a media peripheral using a remote control, or a third (3^{rd}) party may initiate a test of the media peripheral remotely. For example, a battery condition level of a media peripheral which may indicate whether the battery needs to be recharged or not, may be remotely checked. Other key features such as configuration information may also be examined or checked as well. Checking certain features of a media peripheral, such as a battery charge level, may also be configured or scheduled to be performed periodically and automatically without user initiation or intervention. Accordingly, a user may be alerted, via a display screen such as the television screen, when a problem is identified and/or whether some action needs to be taken. In cases where user intervention may be required, real time alerts may be delivered to the user. In the case of non-critical or informational alerts, these may be delivered at a later time such as during off peak hours.

For example, the third (3^{rd}) party peripheral/PC/PDA/home appliance support services 132 in external support system 104 may check a battery charge level of the media peripheral 113, which may be situated at the second or remote location 102 once per day. The execution and communication of the service may be accomplished from external support system 104 to communication infrastructure 105, on to media processing system 117, and finally to media peripheral 113. In instances where the battery charge level is determined to be low, external support system 104 may deliver, in a similar manner, a pop-up warning or banner that may appear on the screen 119 of media processing 117. This pop-up or banner may operate as an indication to the user, alerting the user to re-charge or change the battery for the media peripheral 113.

An embodiment of the invention may also include providing remote media peripheral updates. In this regard, a user may initiate various media peripheral commands that may result in the performance of software and/or firmware upgrades of media peripherals. For example, a user may utilize a remote control and television screen 118 to order and download a firmware upgrade from a third (3^{rd}) party provider such as the third party storage and distribution system 127. Alternatively, media peripheral and media processing system updates may be subscription based and as a result, may be scheduled to occur automatically or may be done manually.

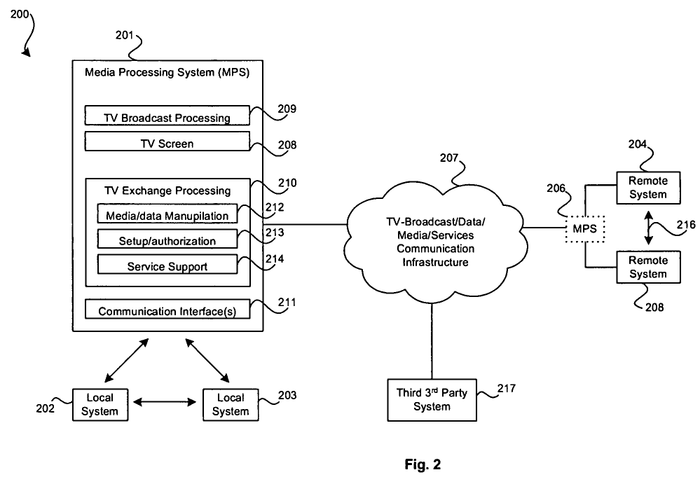

FIG. 2 is a schematic block diagram illustrating communication flow using the TV-based exchange processing of FIG. 1 in accordance with an embodiment of the present invention. Referring to FIG. 2, there is shown an exemplary media exchange network 200 over which media exchange may occur in accordance with an embodiment of the present invention. The media exchange network 200 may include a local media processing 201, a first local system 202, a second local system 203, a first remote system 204, a second remote system 205, an optional media processing system 206, a third (3^{rd}) party system 217 and a communication infrastructure 207. The communication infrastructure 207 may be similar to the communication infrastructure 105 of FIG. 1, and may provide the necessary transport medium for linking the local media processing 201 to the optional media processing system 206 and/or the remote systems 204, 205, and to the third (3^{rd}) party system 217.

The local media processing system 201 may include a television screen 208, a television broadcast processing platform 209, a TV exchange processing platform 210, and communication interfaces 211. The television exchange processing platform 210 may provide the functionality of media/data manipulation 212, setup/authorization 213, and service support 214. The optional media processing system 206 may be similar to the local media processing system 201, and although not shown, may include a television screen, a television broadcast processing platform, a TV exchange processing platform and communication interfaces.

The local systems 202 and 203 and the remote systems 204 and 205 may each include PC's, PDA's, media peripherals, and home appliances similar to that shown in FIG. 1. The communication interfaces 211 in the local media processing system 201, may facilitate media and/or data communication between the local media processing system 201 and the local systems 202, 203 and television screen 208 in local media processing system 201. Similarly, the communication interfaces 211 in the optional media processing system 206 may facilitate media and/or data communication between the optional media processing system 206 and the remote systems 204 and 205 and television screen 208 in optional media processing system 206. Alternatively, communication may occur between, for example, the local system 202 and local system 203 via communication interfaces 211 after the communication is setup, authorized and initiated by the exchange processing platform 210.

Additionally, a peer-to-peer communication link 215 may be provided to support peer-to-peer media and/or data communication between the local system 202 and the local system 203. Similarly, a peer-to-peer communication link 216 may be provided to support peer-to-peer media and/or data communication between the remote systems 204 and 205. The 3^{rd} party system 217 may include any combination of the external support systems 128, 129, 130, 131, 132, 133, all of which are illustrated in FIG. 1.

The communication infrastructure 207 may include cable infrastructure, xDSL infrastructure, Internet infrastructure, or intranet infrastructure or other similar access and/or transport infrastructure that may facilitate the exchange of media between the local media processing system 201 and the optional media processing system 206 and/or the remote systems 204, 205 and/or the third (3^{rd}) party system 217.

In addition to facilitating setup and control functions, the television exchange processing platform 210 illustrated in FIG. 2, may also provide a media/data manipulation function 212, an authorization function 213, and a service support function 214. The television broadcast processing platform 209, however, includes the circuitry for broadcast channel tuning, amplification, and decoding for media consumption and is not utilized for media/data manipulation function 212, setup/authorization function 213, and service support function 214, except for image generation circuitry which is used to drive the television screen for display of a TV channel guide user interface.

In accordance with the arrangements of FIG. 2, media may be communicated between media devices via the television screen using a television channel guide user interface, whether or not the media are consumed, or processed in whole or in part by a television exchange processing platform. For example, video may be transferred or sent from a digital camcorder of local system 203 to be viewed on television screen 208 via television broadcast processing platform 209. Additionally, at the same time, the same video may be sent, via the media processing system 201 using television exchange processing platform 210, via the communication infrastructure 207, to the media processing system 206, and finally to a PC in remote system 204.

Media may be communicated between media devices via a television screen using a television channel guide user interface, independent of television broadcast channel processing and consumption, where a media processing system with television exchange processing may be utilized to initiate and accomplish the exchange of media. For example, data may be sent from a PC on local system 202 via the media processing system 201 using the television exchange processing platform 210 to re-format and hand-off the data, through the communication infrastructure 207, on to the media processing system 206, and finally to a PDA in remote system 205.

Media may also be communicated between media devices via a television screen using a television channel guide user interface, independent of television broadcast channel processing and television exchange processing. In this regard, the media may not be consumed and the television exchange processing is only utilized to setup and initiate the exchange of the media. The exchange may be accomplished through the media processing system's communication interfaces or through a peer-to-peer interface between the media devices. For example, a user may setup and initiate the exchange of status information from a home appliance within local system 202 to a PC with the local system 203 using the media processing system 201 and the television exchange processing platform 210. The actual transfer of the status information may occur after setup and initiation through the peer-to-peer interface 215.

In an illustrative embodiment, a user may select a music channel on their television channel guide user interface at a local site. The selected music file may actually exist on a PC of the remote system 204, for example. The television exchange processing platform 210 of local media processing system 201 may only be utilized to setup the exchange between remote system 204 and the remote system 205. The communication infrastructure 207 may facilitate the exchange of the selected file. In this regard, the television exchange processing platform 210 does not actually accomplish the exchange, but merely facilitates or setup the exchange. The selected music file may subsequently be passed directly, through a peer-to-peer wireless interface 216 from the PC at the remote system 204, to a PC at remote system 205. Accordingly, the television broadcast processing platform 209 is not utilized to consume the selected music.

A third (3^{rd}) party provider such as the third party system 217 or another user, may initiate cues such as pop-up prompts or banners that may appear on a user's television screen via a media exchange network. The third (3^{rd}) party, via the pop-up prompts or the banner, may request authorization from the user to push (3^{rd}) party media, data, and/or services to the user. The user may select or otherwise choose to authorize or reject the request from the third (3^{rd}) party media provider 217 to push the media data and/or service. If the user chooses to accept the request by authorizing the push, then the media, data an/or services may be pushed to media peripherals and/or a PCs associated with the user. Similarly, a user may initiate a request to receive media, data, or services from a third (3^{rd}) party provider. In this case, the media may be received by a media peripheral and/or a PC associated with the user.

For example, the third (3^{rd}) party system 217 may initiate a pop-up prompt to the media processing system 201 via communication infrastructure 207. The pop-up prompt may appear on the television screen 208. The third (3^{rd}) party system 217 may request authorization to send an advertisement to the media processing system 201. A user of the media processing system 201 may accept the request by selecting the pop-up prompt or a portion thereof using their remote control. The acceptance may generate an acceptance message that may be transmitted by television exchange processing platform 210 of the media processing system 201. The acceptance may be received by the third (3^{rd}) party system 217 via communication infrastructure 207. The third (3^{rd}) party system 217 may then push the advertisement to the media processing system 201 via communication infrastructure 207. The advertisement may subsequently appear as a channel program on a TV channel guide user interface displayed on the TV screen 208 of media processing system 201.

U.S. application Ser. No. ______ (Attorney Docket No. 14276US02) discloses a method and system for media processing providing access to a channel guide, aspects of which illustrate exemplary media and device views, the contents of which are incorporated herein by reference in its entirety .

Certain media peripheral commands may be initiated by a user to archive and/or compress digital media. For example, a user may command that digital pictures be pulled from a digital camera at local system 202 to media processing system 201. The pictures may be compressed by the media/data manipulation function 212 in television exchange processing platform 210. The compressed pictures may be stored by media processing system 201 on a media peripheral such as a personal digital assistant (PDA) at local system 202, or on a PC at remote system 204 via communication infrastructure 207 and media processing system 206. The compressed pictures may also be stored at a third (3^{rd}) party system 217, which may provide remote storage via the communication infrastructure 207. In this regard, real time media storage delivery may be accomplished. In each case, the exchange may be accomplished using the television exchange processing platform 210 in the media processing system 201.

Certain media peripheral commands may be initiated by a user to perform feature interrogation. Accordingly, a user may be provided with the capability to access the statistics or status associated with a media peripheral, a media peripheral's version number, model number, serial number, registration information, and other similar type of media peripheral parameter. Exemplary statistics or status may include the resolution of a camera or its zoom setting, for example. Also, a user may control a media delivery format such as a compression format, resolution, general picture quality utilizing the general peripheral support services 132.

For example, media processing system 201 may initiate a command to request a statistics or status file from a home appliance at the remote system 205. The request may be communicated from to media processing system 206 via communication infrastructure 207. The transfer may be coordinated by media processing system 201, using the television exchange processing platform 210. The request may be authorized by the media processing system 206, and the media processing system 206 may retrieve the statistics or status file from the appliance at remote system 205. The status or statistics file may then be delivered to the media processing system 201 by media processing system 206 over a similar, although reversed, communication path.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

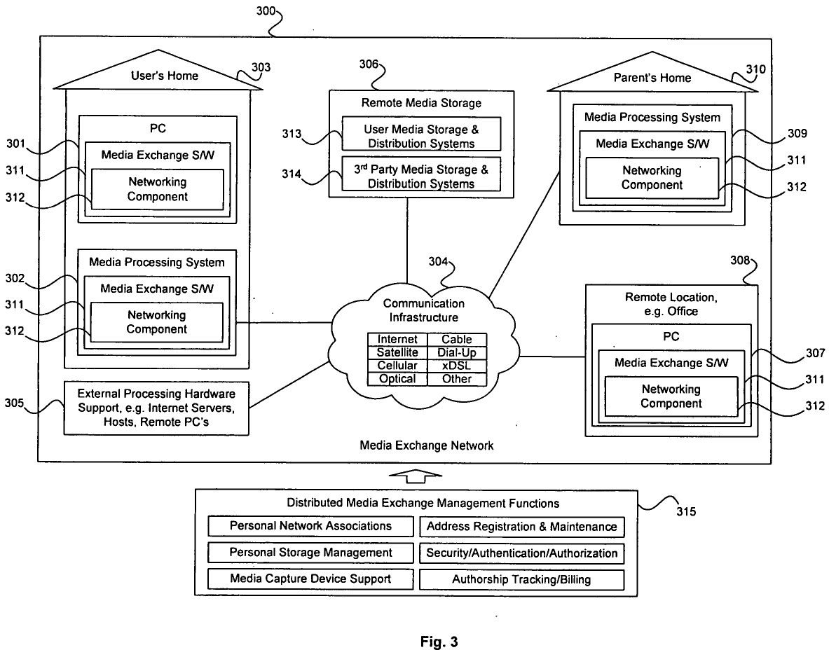

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

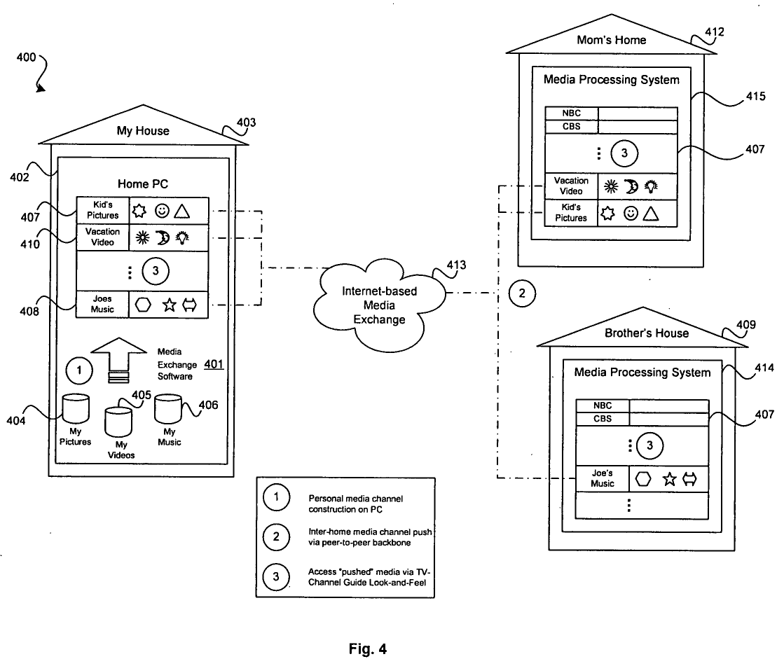

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

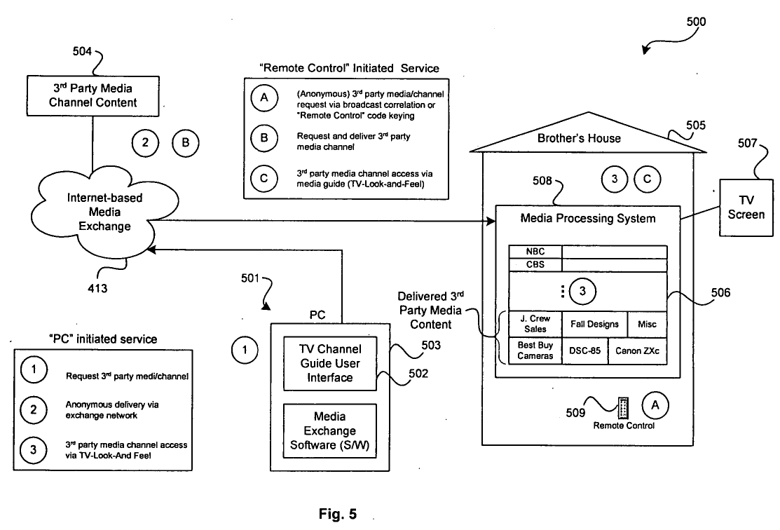

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

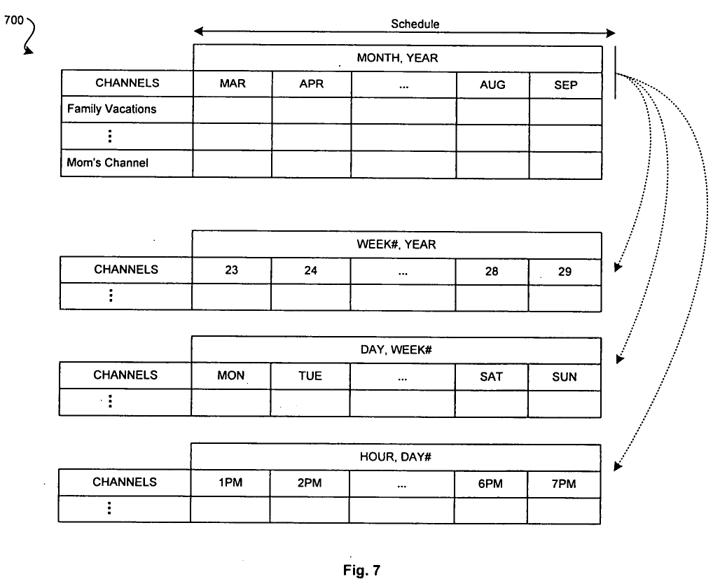

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

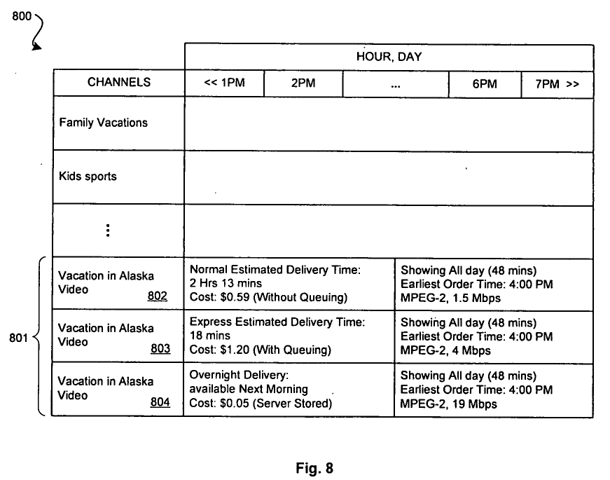

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

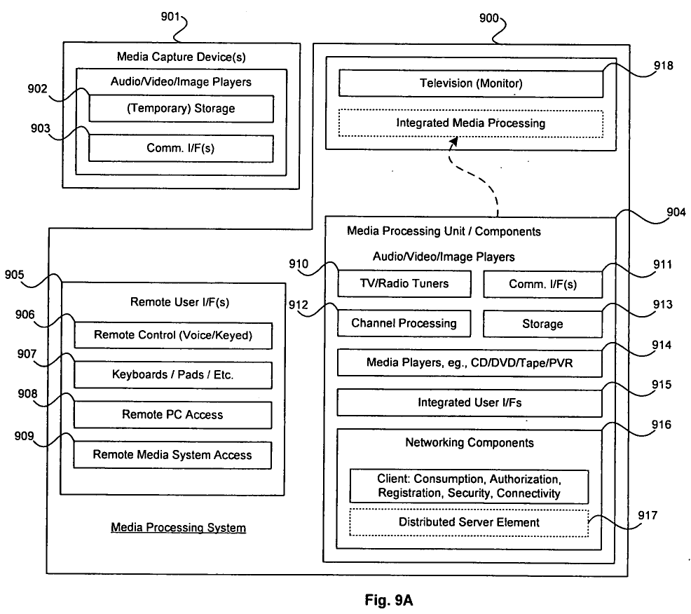

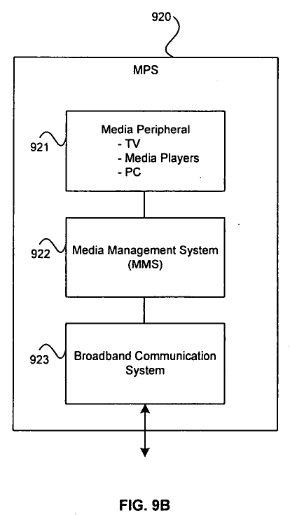

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

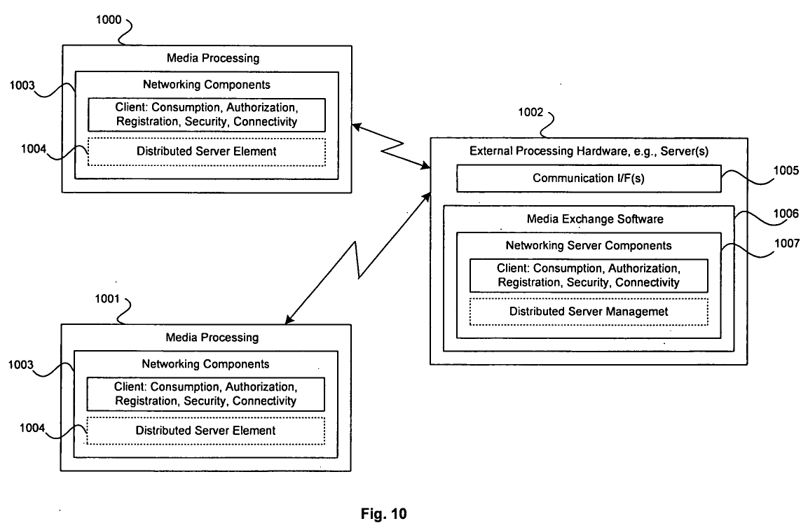

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

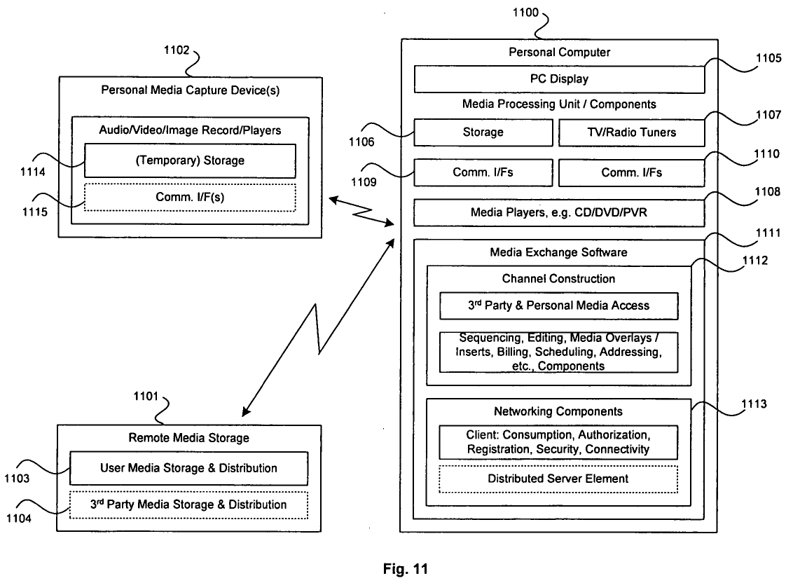

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Aspects of the invention may be found in a method and system for communicating media. The method may include controlling communication of media from a television without consuming the media by the television. The media may be transferred from a first location to at least a second location under the control of the television. At least one command initiated from or through the television may cause the transfer of the media. At least one command may be received that may result in the transfer of media from the first location to the second location. Accordingly, at least one request may be received by the television and utilized to facilitate or control the transfer of media. The transfer or exchange of media may occur in response to the received request.

In one aspect of the invention, the first location and/or the second location may correspond to the location of a media peripheral, a media processing system, a media storage system, a personal computer and/or a third party. The first location and the second location may co-located or they may be remotely located with respect to each other and/or with respect to a user. A user interface may be displayed on the television display and may be utilized to control the transfer of the media. The transfer of the media from the first location to the second location may be scheduled by utilizing the television. However, the scheduling may not result in the television consuming the media. The transferred media may be stored in the first location and/or the second location.

Aspects of a system for communicating information in a distributed media network may include at least one processor that may be configured to control the communication of media from a television. However, control of the communication media does not involve consumption of the media by the television. The processor may include any one or a combination of a computer processor, a media peripheral processor, a media exchange system processor, a television exchange processor, a communication interface processor and a media processing system processor. Notwithstanding, the media may be transferred by the processor from a first location to at least a second location under the control of the television. The processor may initiate at least one command from or through the television that may result in the transfer of the media. Notwithstanding, the media is not consumed by the television in any of these circumstances.

The processor may be configured to receive one or more commands that may also result in the transfer of the media from the first location to the second location. In this regard, the processor may receive at least one request via or through the television and the request may be utilized by the processor to facilitate or control the transfer of media. Responsive to the received request, the processor may effectuate the transfer or exchange of the media without the media being consumed.

The processor may be utilized to display a user interface on the television display and the displayed user interface may be utilized to control the transfer of the media. In one aspect of the invention, the processor may be adapted to schedule the transfer of the media from the first location to the second location. However, the scheduling or any other of these activities may not result in the consumption of the media by the television. The processor may transfer and store the media to the first location and/or the second location. The first location and/or the second location may correspond to the location of a media peripheral, a media processing system, a media storage system, a personal computer and/or a third party such as a third (3^{rd}) party media or content provider. The first location and the second location may be co-located or remotely located with respect to each other and/or with respect to a user.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for supporting communication of media, the method comprising:
controlling communication of the media from a television without consuming the media by said television; and
transferring the media from a first location to at least a second location according to said controlling communication by the television.

2. The method according to claim 1, further comprising generating at least one command from said television causing said transfer of the media.

3. The method according to claim 1, further comprising receiving at least one command that results in said transfer of the media from said first location to said second location.

4. The method according to claim 3, further comprising receiving at least one request by said television for said controlling communication of the media.

5. The method according to claim 4, further comprising responding to said received request, said response resulting is said transfer of the media.

6. The method according to claim 1, wherein said first location and said second location corresponds to a location of at least one of a media peripheral, a media processing system, a media storage system, a personal computer and a third party media provider.

7. The method according to claim 1, wherein said first location and said second location is at least one of co-located and remotely located.

8. The method according to claim 1, further comprising displaying a user interface on a display of said television for said controlling communication of said transfer of the media.

9. The method according to claim 1, further comprising scheduling said transfer of the media from said first location to at least said second location utilizing said television without consuming the media.

10. The method according to claim 1, further comprising storing said transferred media in at least one of said first location and said second location.

11. A machine-readable storage having stored thereon, a computer program having at least one code section for supporting communication of media, the at least one code section being executable by a machine for causing the machine to perform steps comprising:
controlling communication of the media from a television without consuming the media by said television; and
transferring the media from a first location to at least a second location according to said controlling communication by the television.

12. The machine-readable storage according to claim 11, further comprising code for generating at least one command from said television causing said transfer of the media.

13. The machine-readable storage according to claim 11, further comprising code for receiving at least one command that results in said transfer of the media from said first location to said second location.

14. The machine-readable storage according to claim 13, further comprising code for receiving at least one request by said television for said controlling communication of the media.

15. The machine-readable storage according to claim 14, further comprising code for responding to said received request, said response resulting is said transfer of the media.

16. The machine-readable storage according to claim 11, wherein said first location and said second location corresponds to a location of at least one of a media peripheral, a media processing system, a media storage system, a personal computer and a third party media provider.

17. The machine-readable storage according to claim 11, wherein said first location and said second location is at least one of co-located and remotely located.

18. The machine-readable storage according to claim 11, further comprising code that causes display of a user interface on a display of said television for said controlling communication of said transfer of the media.

19. The machine-readable storage according to claim 11, further comprising code for scheduling said transfer of the media from said first location to at least said second location utilizing said television without consuming the media.

20. The machine-readable storage according to claim 11, further comprising code for storing said transferred media in at least one of said first location and said second location.

21. A system for supporting communication of media within a home, the system comprising:
a media peripheral;
a television that is utilized to arrange media delivery to the media peripheral for playback on said media peripheral; and
a communication pathway that operates independent of the television through which the media is delivered.

22. The system according to claim 21, wherein said television generates at least one command that causes said media delivery.

23. The system according to claim 22, wherein said television responds to said at least one command resulting in said media delivery.

24. The system according to claim 21, wherein said television displays a user interface that is utilized to control said media delivery.

25. The system according to claim 24, wherein said user interface provides an indication of said media peripheral.

26. The system according to claim 25, wherein upon selection of said indication of said media peripheral in said user interface, said media delivery is initiated.

27. A system supporting communication of media, the system comprising:
a media peripheral located at a first home; and
a television located at a second home, wherein said television is utilized to arrange delivery of media to said media peripheral.

28. The system according to claim 27, wherein said television retrieves stored media and transfers said stored media to at least one of a media peripheral located at a first home and a media peripheral remotely located with respect to said first home.

29. The system according to claim 27, wherein said television schedules said delivery of media to said media peripheral.

30. The system according to claim 27, wherein said television redirects delivery of media to said media peripheral without said television at least one of receiving and consuming the media.
